(19) United States
(12) Patent Application Publication
(10) Pub. No.: US 2025/0139462 A1
(43) Pub. Date: May 1, 2025

(54) DYNAMIC ARTIFICIAL INTELLIGENCE SYSTEM WITH FEEDBACK CONTROL UTILIZING COUNTERFACTUAL INFORMATION

(71) Applicant: Dell Products L.P., Round Rock, TX (US)

(72) Inventors: Yasmin Mansy, New Cairo (EG); Brendan Burns Healy, Haddonfield, NJ (US); Mahi Ismail, New Cairo (EG)

(21) Appl. No.: 18/495,221

(22) Filed: Oct. 26, 2023

(51) Int. Cl. G06N 5/022; G06N 10/60; G06Q 10/04

(52) U.S. Cl. CPC G06N 5/022; G06N 10/60; G06Q 10/04

(57) ABSTRACT

An apparatus comprises at least one processing device configured generate a configuration of an artificial intelligence system for solving an optimization problem, the generated configuration comprising one or more parameters each having an associated parameter value range. The at least one processing device is also configured to execute one or more annealing processes in the artificial intelligence system with the generated configuration to determine a given solution to the optimization problem, to generate counterfactual configurations of the artificial intelligence system, and to execute the annealing processes in the artificial intelligence system with the generated counterfactual configurations to determine counterfactual information for the given solution. The at least one processing device is further configured to generate feedback for the artificial intelligence system based at least in part on the determined counterfactual information, and to control characteristics of the artificial intelligence system based at least in part on the generated feedback.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

Various types of computing algorithms may be used to solve optimization problems, where the goal is to search for an optimal, or sometimes near-optimal, one of potentially many different solutions to a problem. For example, annealing processes such as simulated annealing processes, digital annealing processes and quantum annealing processes may be used for solving optimization problems. In some cases, an optimization problem may be framed as an energy minimization problem, where physics dictates that systems tend to seek minimum energy states. This behavior also follows in quantum physics. Quantum annealing processes utilize quantum physics to find low-energy states corresponding to solutions to an optimization problem.

### SUMMARY

Illustrative embodiments of the present disclosure provide techniques for implementing dynamic artificial intelligence systems with feedback control utilizing counterfactual information. In one embodiment, an apparatus comprises at least one processing device comprising a processor coupled to a memory. The at least one processing device is configured to generate a configuration of an artificial intelligence system for solving an optimization problem, the generated configuration comprising one or more parameters, each of the one or more parameters having an associated parameter value range. The at least one processing device is also configured to execute one or more annealing processes in the artificial intelligence system with the generated configuration to determine a given solution to the optimization problem, to generate one or more counterfactual configurations of the artificial intelligence system, and to execute the one or more annealing processes in the artificial intelligence system with the generated one or more counterfactual configurations to determine counterfactual information for the given solution to the optimization problem. The at least one processing device is further configured to generate feedback for the artificial intelligence system based at least in part on the determined counterfactual information, and to control one or more characteristics of the artificial intelligence system based at least in part on the generated feedback.

These and other illustrative embodiments include, without limitation, methods, apparatus, networks, systems and processor-readable storage media.

### BRIEF DESCRIPTION OF THE DRAWINGS

FIG. 1 is a block diagram of an information processing system configured for implementing dynamic artificial intelligence systems with feedback control utilizing counterfactual information in an illustrative embodiment.

FIG. 2 is a flow diagram of an exemplary process for implementing dynamic artificial intelligence systems with feedback control utilizing counterfactual information in an illustrative embodiment.

FIG. 3 shows a plot illustrating a search for solution to an energy minimization problem in an illustrative embodiment.

FIG. 4 shows a plot illustrating a quantum tunnelling approach for finding a solution to an energy minimization problem in an illustrative embodiment.

FIGS. 5A-5C show graphs illustrating a formulation of a traveling salesman problem and possible route solutions for the traveling salesman problem in an illustrative embodiment.

FIG. 6 shows a graph of another formulation of a traveling salesman problem in an illustrative embodiment.

FIGS. 7A-7D show plots illustrating search for counterfactual explanations for an optimization problem in an illustrative embodiment.

FIG. 8 shows pseudocode for implementing counterfactual searches and generation of counterfactual explanations utilizing an annealer in an illustrative embodiment.

FIG. 9 shows a process flow for generating counterfactual explanations in an explainable artificial intelligence framework in an illustrative embodiment.

FIGS. 10A-10F show pseudocode for implementation of an explainable artificial intelligence framework configured to generate counterfactual explanations in an illustrative embodiment.

FIG. 11 shows counterfactual explanation output generated by an explainable artificial intelligence framework in an illustrative embodiment.

FIGS. 12 and 13 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

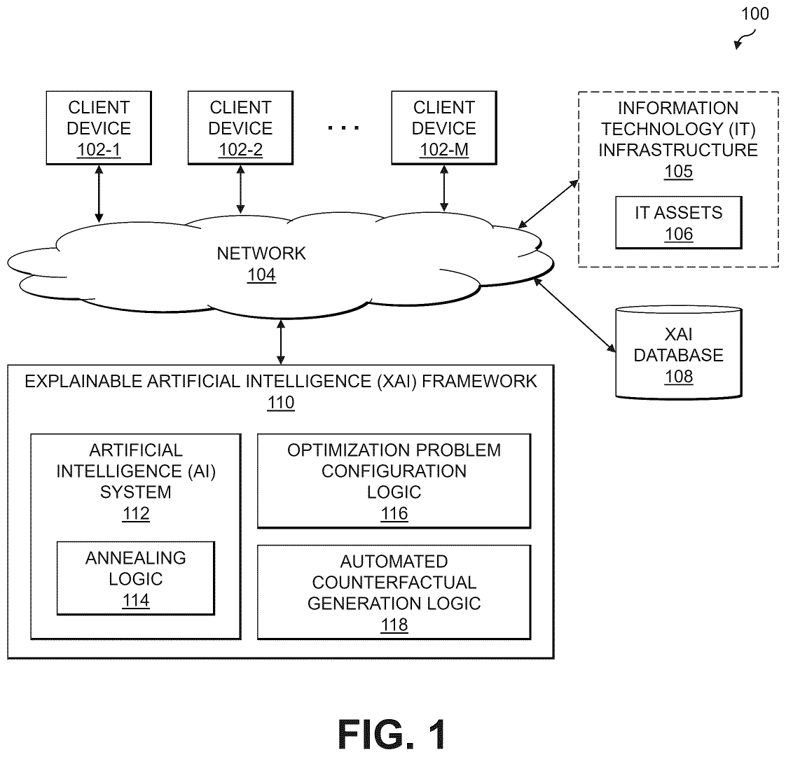

FIG. 1 shows an information processing system 100 configured in accordance with an illustrative embodiment. The information processing system 100 is assumed to be built on at least one processing platform and provides functionality for implementing dynamic artificial intelligence (AI) systems with feedback control utilizing counterfactual information. The information processing system 100 includes a set of client devices 102-1, 102-2, . . . 102-M (collectively, client devices 102) which are coupled to a network 104. Also coupled to the network 104 is an IT infrastructure 105 comprising one or more IT assets 106, an explainable AI (XAI) database 108, and an XAI framework 110. As used here, explainable AI or XAI is intended to be construed broadly and includes various approaches for explaining complicated technologies, which include but are not limited to AI, machine learning, annealing processes, etc. In some embodiments, the XAI framework 110 implements functionality for explaining Quantum Annealing (QA) processes and thus may be referred to as an explainable QA (xQA) framework. The IT assets 106 may comprise physical and/or virtual computing resources in the IT infrastructure 105. Physical computing resources may include physical hardware such as servers, storage systems, networking equipment, Internet of Things (IoT) devices, other types of processing and computing devices including desktops, laptops, tablets, smartphones, etc. Virtual computing resources may include virtual machines (VMs), containers, etc.

In some embodiments, the XAI framework 110 is used for an enterprise system. For example, an enterprise may subscribe to or otherwise utilize the XAI framework 110 for managing the use of outputs of AI systems including AI system 112. For example, users of the client devices 102 may utilize the AI system 112 to run one or more AI or machine learning algorithms to generate actionable insight (e.g., such as for configuring and/or managing the IT assets 106 of the IT infrastructure 105). As used herein, the term “enterprise system” is intended to be construed broadly to include any group of systems or other computing devices. For example, the IT assets 106 of the IT infrastructure 105 may provide a portion of one or more enterprise systems. A given enterprise system may also or alternatively include one or more of the client devices 102 and/or the XAI framework 110. In some embodiments, an enterprise system includes one or more data centers, cloud infrastructure comprising one or more clouds, etc. A given enterprise system, such as cloud infrastructure, may host assets that are associated with multiple enterprises (e.g., two or more different businesses, organizations or other entities).

The client devices 102 may comprise, for example, physical computing devices such as IoT devices, mobile telephones, laptop computers, tablet computers, desktop computers or other types of devices utilized by members of an enterprise, in any combination. Such devices are examples of what are more generally referred to herein as “processing devices.” Some of these processing devices are also generally referred to herein as “computers.” The client devices 102 may also or alternately comprise virtualized computing resources, such as VMs, containers, etc.

The client devices 102 in some embodiments comprise respective computers associated with a particular company, organization or other enterprise. Thus, the client devices 102 may be considered examples of assets of an enterprise system. In addition, at least portions of the information processing system 100 may also be referred to herein as collectively comprising one or more “enterprises.” Numerous other operating scenarios involving a wide variety of different types and arrangements of processing nodes are possible, as will be appreciated by those skilled in the art.

The network 104 is assumed to comprise a global computer network such as the Internet, although other types of networks can be part of the network 104, including a wide area network (WAN), a local area network (LAN), a satellite network, a telephone or cable network, a cellular network, a wireless network such as a WiFi or WiMAX network, or various portions or combinations of these and other types of networks.

The XAI database 108 is configured to store and record various information that is utilized by the XAI framework 110. Such information may include, for example, information relating to configurations for optimization problems to be solved utilizing annealing logic 114 of the AI system 112, solutions to the optimization problems provided by the annealing logic 114 of the AI system 112, counterfactual explanations for the solutions to the optimization problems provided by the annealing logic 114 of the AI system 112, etc. In some embodiments, one or more storage systems utilized to implement the XAI database 108 comprise a scale-out all-flash content addressable storage array or other type of storage array. Various other types of storage systems may be used, and the term “storage system” as used herein is intended to be broadly construed, and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

Although not explicitly shown in FIG. 1, one or more input-output devices such as keyboards, displays or other types of input-output devices may be used to support one or more user interfaces to the XAI framework 110, as well as to support communication between the XAI framework 110 and other related systems and devices not explicitly shown.

The XAI framework 110 may be provided as a cloud service that is accessible by one or more of the client devices 102 to allow users thereof to manage generation of counterfactual information (e.g., counterfactual explanations) for solutions to optimization problems provided by the annealing logic 114 of the AI system 112. The client devices 102 may be configured to access or otherwise utilize the XAI framework 110 (e.g., to configure the AI system 112 to solve a particular optimization problem, to receive output solutions for the optimization problem, to configure the AI system 112 to provide counterfactual explanations to the output solutions for the optimization problem, etc.). In some embodiments, the client devices 102 are assumed to be associated with system administrators, IT managers or other authorized personnel responsible for managing use of AI or machine learning for an enterprise. In some embodiments, the IT assets 106 of the IT infrastructure 105 are owned or operated by the same enterprise that operates the XAI framework 110 (and, in some cases, the XAI framework 110 or portions thereof such as the AI system 112 may be implemented on or utilizing the IT assets 106 of the IT infrastructure 105). In other embodiments, the IT assets 106 of the IT infrastructure 105 may be owned or operated by one or more enterprises different than the enterprise which operates the XAI framework 110. Various other examples are possible.

In some embodiments, the client devices 102 and/or the IT assets 106 of the IT infrastructure 105 may implement host agents that are configured for automated transmission of information with the XAI framework 110 regarding optimization problems to be solved by the AI system 112, counterfactual explanations for solutions to optimization problems solved by the AI system 112, etc. It should be noted that a “host agent” as this term is generally used herein may comprise an automated entity, such as a software entity running on a processing device. Accordingly, a host agent need not be a human entity.

The XAI framework 110 in the FIG. 1 embodiment is assumed to be implemented using at least one processing device. Each such processing device generally comprises at least one processor and an associated memory, and implements one or more functional modules or logic for controlling certain features of the XAI framework 110. In the FIG. 1 embodiment, the XAI framework 110 implements an AI system 112 comprising annealing logic 114, as well as optimization problem configuration logic 116 and automated counterfactual generation logic 118. The AI system 112 is configured to implement one or more AI or machine learning algorithms. For example, the AI system 112 may utilize the annealing logic 114 for determining solutions to optimization problems which are configured in accordance with the optimization problem configuration logic 116. Such configuration, for example, may include specification of parameters and their associated parameter value ranges, constraints, an objective function, etc. for an optimization problem. The annealing logic 114 may then implement one or more annealing processes, such as a quantum annealing process utilizing a quantum computing device, a simulated annealing process utilizing a classical computing device, etc. The annealing processes implemented by the annealing logic 114 will determine a solution (e.g., an optimal or near-optimal solution) to the optimization problem. The automated counterfactual generation logic 118 is configured to analyze the determined solution to the optimization problem and identify a modified configuration of the AI system 112 (e.g., modified parameter value ranges for one or more parameters of the optimization problem). The annealing logic 114 then runs the one or more annealing processes utilizing the modified configuration to determine counterfactual explanations for the determined solution to the optimization problem. Such counterfactual explanations may be output (e.g., in a graphical user interface (GUI) of the XAI framework 110). The counterfactual explanations may be used to reformulate the optimization problem, such as by determining modifications of the constraints of the optimization problem which result in a better solution to the optimization problem. Thus, the automated counterfactual generation logic 118 may provide feedback which is utilized by the optimization problem configuration logic 116 to re-formulate the optimization problem and then execute the re-formulated optimization problem utilizing the AI system 112.

At least portions of the AI system 112, the annealing logic 114, the optimization problem configuration logic 116 and the automated counterfactual generation logic 118 may be implemented at least in part in the form of software that is stored in memory and executed by a processor. In some cases, at least a portion of the AI system 112 (e.g., the annealing logic 114) is implemented utilizing a quantum annealer of a quantum computer.

It is to be appreciated that the particular arrangement of the client devices 102, the IT infrastructure 105, the XAI database 108 and the XAI framework 110 illustrated in the FIG. 1 embodiment is presented by way of example only, and alternative arrangements can be used in other embodiments. For example, the XAI framework 110 (or portions of components thereof, such as one or more of the AI system 112, the annealing logic 114, the optimization problem configuration logic 116 and the automated counterfactual generation logic 118) may in some embodiments be implemented internal to one or more of the client devices 102 and/or the IT infrastructure 105.

The XAI framework 110 and other portions of the information processing system 100, as will be described in further detail below, may be part of cloud infrastructure.

The XAI framework 110 and other components of the information processing system 100 in the FIG. 1 embodiment are assumed to be implemented using at least one processing platform comprising one or more processing devices each having a processor coupled to a memory. Such processing devices can illustratively include particular arrangements of compute, storage and network resources.

The client devices 102, IT infrastructure 105, the IT assets 106, the XAI database 108 and the XAI framework 110 or components thereof (e.g., the AI system 112, the annealing logic 114, the optimization problem configuration logic 116, and the automated counterfactual generation logic 118) may be implemented on respective distinct processing platforms. In some embodiments, for example, some components such as the annealing logic 114 (e.g., implemented as a quantum annealer) are executed on a quantum computing-based processing platform and other components such as the optimization problem configuration logic 116 and/or the automated counterfactual generation logic 118 are executed on a classical computing-based processing platform. This, however, is not a requirement. In some embodiments, all components of the XAI framework 110 are implemented on one or more quantum computing-based processing platforms or all components of the XAI framework 110 are implemented on one or more classical computing-based processing platforms (e.g., including where the annealing logic 114 is implemented via a simulated annealer). As another example, in some embodiments at least portions of the XAI framework 110 and one or more of the client devices 102, the IT infrastructure 105, the IT assets 106 and/or the XAI database 108 are implemented on the same processing platform. A given client device (e.g., 102-1) can therefore be implemented at least in part within at least one processing platform that implements at least a portion of the XAI framework 110.

The term “processing platform” as used herein is intended to be broadly construed so as to encompass, by way of illustration and without limitation, multiple sets of processing devices and associated storage systems that are configured to communicate over one or more networks. For example, distributed implementations of the information processing system 100 are possible, in which certain components of the system reside in one data center in a first geographic location while other components of the system reside in one or more other data centers in one or more other geographic locations that are potentially remote from the first geographic location. Thus, it is possible in some implementations of the information processing system 100 for the client devices 102, the IT infrastructure 105, IT assets 106, the XAI database 108 and the XAI framework 110, or portions or components thereof, to reside in different data centers. Numerous other distributed implementations are possible. The XAI framework 110 can also be implemented in a distributed manner across multiple data centers.

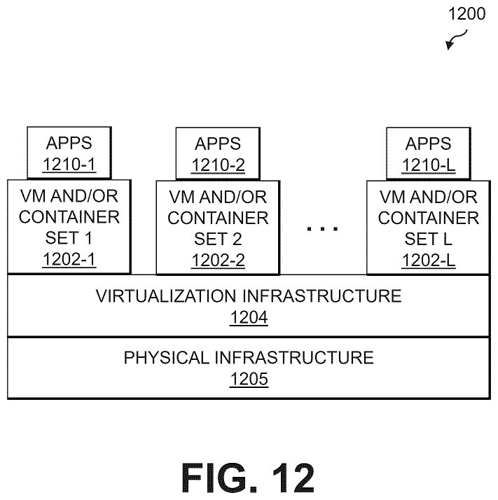

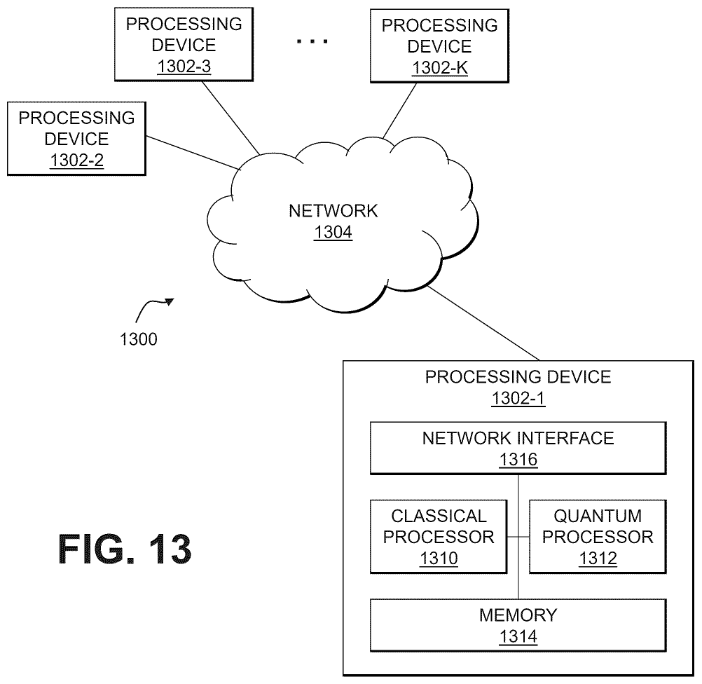

Additional examples of processing platforms utilized to implement the XAI framework 110 and other components of the information processing system 100 in illustrative embodiments will be described in more detail below in conjunction with FIGS. 12 and 13.

It is to be understood that the particular set of elements shown in FIG. 1 for generating counterfactual explanations for solutions to optimization problems obtained utilizing AI systems is presented by way of illustrative example only, and in other embodiments additional or alternative elements may be used. Thus, another embodiment may include additional or alternative systems, devices and other network entities, as well as different arrangements of modules and other components.

It is to be appreciated that these and other features of illustrative embodiments are presented by way of example only, and should not be construed as limiting in any way.

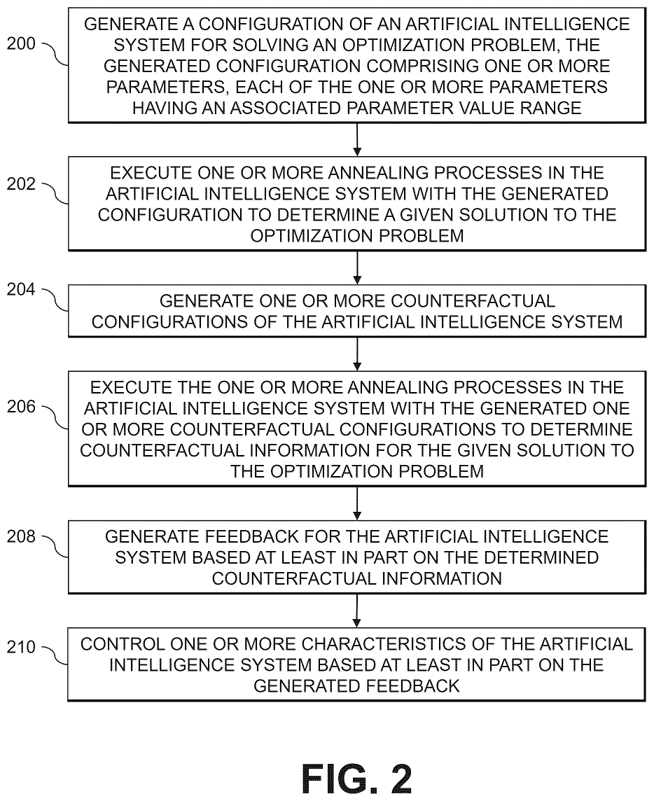

An exemplary process for generating counterfactual explanations for solutions to optimization problems obtained utilizing AI systems will now be described in more detail with reference to the flow diagram of FIG. 2. It is to be understood that this particular process is only an example, and that additional or alternative processes for generating counterfactual explanations for solutions to optimization problems obtained utilizing AI systems may be used in other embodiments.

In this embodiment, the process includes steps 200 through 210. These steps are assumed to be performed by the XAI framework 110 utilizing the AI system 112, the annealing logic 114, the optimization problem configuration logic 116 and the automated counterfactual generation logic 118. The process begins with step 200, generating a configuration of an AI system for solving an optimization problem. The generated configuration comprises one or more parameters, each of the one or more parameters having an associated parameter value range. In step 202, one or more annealing processes are executed in the AI system with the generated configuration to determine a given solution to the optimization problem. The AI system may comprise a quantum annealer implementing the one or more annealing processes.

One or more counterfactual configurations of the AI system are generated in step 204. A given one of the one or more counterfactual configurations may comprise at least one modified parameter value range for at least one of the one or more parameters. The at least one modified parameter value range for said at least one of the one or more parameters may comprise a narrower parameter value range for said at least one of the one or more parameters. Generating a given one of the one or more the counterfactual configurations may comprise selecting a given one of the one or more parameters associated with the given solution to the optimization problem, and generating a given modified parameter value range for the given parameter for the given counterfactual configuration, the given modified parameter value range excluding a value of the given parameter associated with the given solution to the optimization problem. The given parameter may be selected based at least in part on determining impacts of two or more different ones of the one or more parameters on the given solution to the optimization problem, wherein the impacts of the two or more different ones of the one or more parameters on the given solution to the optimization problem are determined based at least in part on identifying contributions of two or more constraints of the optimization problem to the given solution to the optimization problem, the two or more constraints being associated with different subsets of the one or more parameters of the optimization problem. The impacts of the two or more different ones of the one or more parameters on the given solution to the optimization problem may be determined utilizing a causal inference algorithm, wherein the causal inference algorithm comprises an Inductive Causation (IC) algorithm utilizing a Bayesian Information Criterion (BIC) scoring metric.

In some embodiments, generating the one or more counterfactual configurations comprises selecting a given one of the one or more parameters associated with the given solution to the optimization problem and at least one of (i) generating a first modified parameter value range for the given parameter for a first one of the one or more counterfactual configurations, the first modified parameter value range comprising a first value range less than a value of the given parameter associated with the given solution to the optimization problem and (ii) generating a second modified parameter value range for the given parameter for a second one of the one or more counterfactual configurations, the second modified parameter value range comprising a second value range greater than the value of the given parameter associated with the given solution to the optimization problem.

The one or more annealing processes are executed in the AI system in step 206 with the generated one or more counterfactual configurations to determine counterfactual information for the given solution to the optimization problem. The determined counterfactual information may comprise one or more counterfactual explanations, each of the one or more counterfactual explanations comprising an alternate solution to the optimization problem.

Feedback for the AI system is generated in step 208 based at least in part on the determined counterfactual information. The feedback may comprise an explanation of optimality of the given solution to the optimization problem relative to the determined counterfactual information (e.g., counterfactual explanations or alternative solutions obtained be executing the annealing processes using the generated counterfactual configurations). One or more characteristics of the AI system are controlled in step 210 based at least in part on the generated feedback. Characteristics of the AI system which may be controlled include, for example, the configuration (e.g., parameter value ranges, constraints) which are used by the AI system, how results from the AI system are presented to end-users (e.g., generating reports with the given solution as well as the counterfactual information to provide evidence of the relative optimality of the given solution compared with alternative solutions obtained using the counterfactual configurations, etc.).

Generating the feedback for the AI system may comprise identifying one or more modifications to the optimization problem to increase an optimality of the given solution to the optimization problem, the one or more modifications to the optimization problem comprising one or more changes to at least one of (i) one or more parameter value ranges for the one or more parameters of the optimization problem and (ii) one or more constraints of the optimization problem.

In some embodiments, the given solution to the optimization problem specifies one or more controls for a physical system which provide a first level of performance of the physical system and the determined counterfactual information specifies alternate sets of the one or more controls for the physical system providing one or more second levels of performance of the physical system, the one or more second levels of performance of the physical system being less than the first level of performance of the physical system. The FIG. 2 process may further include adjusting the one or more controls of the physical system based at least in part on the given solution to the optimization problem and the determined one or more counterfactual explanations for the given solution to the optimization problem. The physical system may comprise one or more IT assets of an IT infrastructure.

Annealers work fundamentally different from other types of computing hardware, harnessing the laws of physics to quickly explore large search spaces. There are different types of annealers, including digital annealers, simulated annealers, and quantum annealers. These annealers work effectively on optimization problems, or problems which can be expressed as optimization problems. Annealers, however, may require specialized inputs. For example, some annealers require input in the form of QUBOs (e.g., Quadratic Unconstrained Binary Optimizations).

Gate-based computing is used in various “classical” processors (e.g., hardware processors found in many desktop and laptop computers). Such classical processors work by applying gates to sets of bits, where the gates may apply various logic (e.g., AND, OR, XOR, etc.). By using a universal set of such logic gates, classical processors can perform arbitrary computations.

Annealing, historically, was a process of cooling materials forged into a specific shape in a controlled way so they would maintain a desired shape. The principle of minimal energy states that, for a closed system with constant external parameters and entropy, the internal energy will decrease and approach a minimum value at equilibrium. Bits in a physical system may take on two values (e.g., 0 or 1). Electrons and other subatomic particles, for example, carry a property called spin, which takes on the value of “up” or “down” which may be mapped to 0 and 1 bit values. Spin, similar to electric charge, responds to changes in the magnetic field, which enables the manipulation of physical bits.

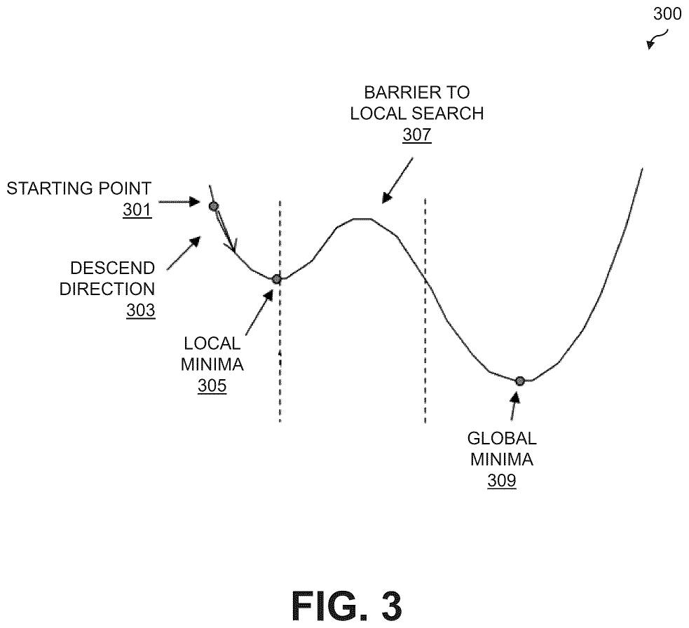

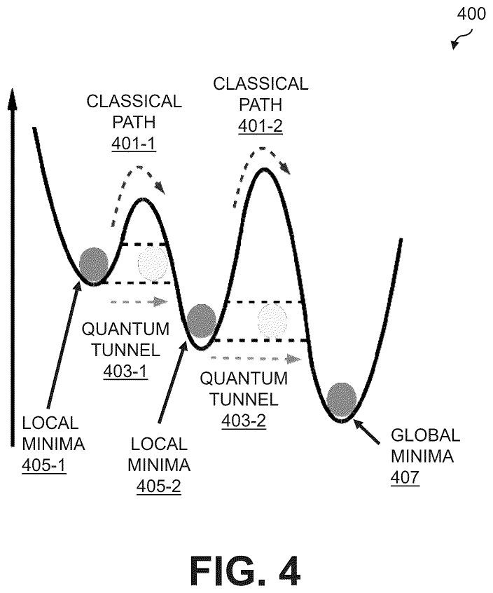

The process of computation using annealing includes setting up the physical environment, and initializing the bits (e.g., setting all electrons to spin “down” for instance). Physical changes are then applied to the environment to represent both the constraints and the objective function to be computed. The system is then allowed to slowly come to equilibrium. Results are then read off the physical bits. Visually, the energy of the system can be thought of as a function of the inputs. Thus, the objective function of two variables (e.g., z=f(x, y)) can be thought of as a “wavy plane.” As the system evolves, the energy (e.g., represented in the “z” axis”) naturally minimizes. Visually, the state “rolls downhill” in the energy landscape. A problem with energy minimization, however, is that there may be multiple “local” minima as well as a “global” minima. This is illustrated in FIG. 3, which shows a plot 300 including a starting point 301, a descend direction 303, a local minima 305, a region 307 presenting a barrier to local search, and a global minima 309. Quantum behavior is valuable in annealing, because quantum mechanics can overcome these barriers to the global minima via quantum tunneling, which is illustrated in the plot 400 of FIG. 4, showing the classical paths 401-1 and 401-2 (collectively, classical paths 401) which would be performed by classical physics, as well as the tunnel effects 403-1 and 403-2 (collectively, tunnel effects 403) achieved via quantum tunneling to go through the local minima 405-1 and 405-2 (collectively, local minima 405) to obtain the global minima 407 solution.

Quantum annealing is a method of quantum computing which may be used to find the optimal solution for problems which potentially have a large number of solutions (e.g., a global minima and multiple local minima). Quantum annealing may utilize various properties of quantum physics, including quantum tunneling, entanglement and superposition. Quantum annealing is a type of quantum computing which may be used to find solutions (e.g., for “NP hard” problems) and is advantageously less affected by noise than other types of quantum computing (e.g., such as gate model quantum computing). Thus, quantum annealing can practically utilize more quantum bits (qubits). In a quantum annealer, states may be represented as energy levels. The states may be simulated by taking advantage of superposition and entanglement properties of qubits in order to obtain the lowest energy result (e.g., the optimal solution, a most likely solution, etc.). Quantum annealers may utilize quantum coupling properties to provide coupled qubits. With quantum entanglement, each qubit in a set of coupled qubits can affect the other qubits' state such that each solution creates a new state. The quantum annealer can calculate the lowest energy level among these states for the coupled qubits, with the lowest energy level providing the optimal solution, the most likely solution, etc.

There are various physical restrictions on annealers. This is represented by QUBO, where:
Quadratic—It is only feasible (at scale) to introduce relationships between pairs of physical bits;
Unconstrained—Nature will explore all options, whether it is desired to do so or not;
Binary—Reliance on physical bits means variables are either 0 or 1; and
Optimization—The output of the process will always be a minimum.

An example of QUBO will now be described. Consider a group of people denoted A, B, C and D who will be sorted into two groups (e.g., group 0 and group 1). This may be represented as a function:

$$F ( A , B , C , D ) = x A B + y A C + z A D + w B C + u B D + v C D + a A A + b B B + c C C + d D D$$

This may be simplified or adjusted using various constraints, such as: that A and C are friends and want to be in the same group; that B doesn't like A and doesn't want to be in A's group; and that C and D would like to be in group 0:

$$F ( A , B , C , D ) = A * B + ( A - 1 ) * ( B - 1 ) + A * ( C - 1 ) + ( A - 1 ) * C + C C + DD = AB + A B - A - B + A C - A + A C - C + C C + DD = 2 AB + 2 A C - 2 A A - 1 B B + 1 DD ( + 0 other terms )$$

There is thus a solution to the earlier problem, when X=0 or X=1, X²=X. Given the constraints above, A=0, B=1, C=0, D=0:

$$F ( A , B , C , D ) = A * B + ( A - 1 ) * ( B - 1 ) + A * ( C - 1 ) + ( A - 1 ) * C + C C + D D = 0$$

If the objective function has no in-bound solutions, a set of parameter values will still be returned. In this case, it will be a solution which is “least” out of bounds. If there are multiple different solutions providing the (global) minimal energy then, in theory, the one closest to the initial configuration should be found. However, in practice, the annealer will often return a random solution with the minimal energy.

Explainable artificial intelligence (XAI) helps humans to understand the reasoning behind predictions made by artificial intelligence (AI) models. XAI may be used for debugging and interpretation, as well as improving the performance of AI models. XAI is particularly useful with regards to building trust and confidence for the adoption of complex AI technologies. Illustrative embodiments provide technical solutions which automate the generation of counterfactual explanations for AI explainability. Counterfactual explanations work by providing alternatives or “what if” scenarios which explain how changes in an input X can result in a different output Y. XAI forms a solution and an enabler for quantum annealing. Counterfactual explanations can provide greater value for the results of quantum annealers. The technical solutions described herein provide functionality for enabling a quantum annealer to explore a narrower search space to come up with “counterfactual” alternative solutions, which explain the inadequateness of such counterfactual alternative solutions relative to the optimal output (e.g., of the broader search space) of the quantum annealer.

In some embodiments, an XAI framework is provided with one or more interfaces (e.g., a graphical user interface (GUI), one or more application programming interfaces (APIs), etc.) enabling developers or other end-users to input an optimization problem in the form of parameters and constraints, and then run the optimization problem on an annealer (e.g., a quantum annealer) to receive a viable solution output along with one or more counterfactual explanations (e.g., explorative and predictive views). The XAI framework may be configured to suggest solutions with a minimum number of parameters to change by prioritizing the tweaking of parameters that affect the output the most. The XAI framework interfaces may allow developers or other end-users to indicate a desire to view other alternative solutions, so that the explainer tweaks the parameters and re-runs the annealing process until the solution space is exhausted. The XAI framework can advantageously be used for various types of optimization problems, including by way of example optimization problems with numerical constrained parameters.

AI systems may be used to solve complex and critical problems in an efficient and error-free manner. Nevertheless, there is still a public concern and distrust towards the full autonomous use of such systems, which is a result or effect of AI systems operating in an unintuitive way (e.g., due to their ability to detect unnoticed patterns). As a result, it is vital for the decisions made by such complicated AI systems to be explained and justified (e.g., to human users). This can be done using XAI, which is a suite of machine learning techniques aimed at producing AI models that are comprehendible and transparent. XAI may operate by producing an explanation of an AI system's operation. This explanation may be a “methodological” explanation or a “counterfactual” explanation. A methodological explanation justifies a decision made by an AI system by recognizing the steps that an AI model takes from an input X to an output Y. An example of a methodological explanation would be: “input X caused P which caused Q and resulted in output Y.” Even though this type of explanation is informative, it is difficult to come up with action items to prevent the occurrence of, or reproduce the output Y. On the other hand, a counterfactual explanation provides alternative or “what if” scenarios to the user, explaining how changes in the input X result in a different output Y. An example of a counterfactual explanation would be: “if X did not occur, then P would also not occur, Q would have still occurred and Z rather than Y would be output.” It is evident that actions can be drawn from the counterfactual explanation easier than from the methodological explanation. Thus, counterfactual explanations may be preferable given complex and sensitive AI systems. Counterfactual explanations may also be used in combination with methodological explanations in some cases.

A quantum annealer is an example of a complicated system that can benefit from the user of counterfactual explanations. A quantum annealer is designed to solve optimization problems given a set of candidate solutions. It does this by finding the global minima of a given objective function over a discrete search space with multiple local minima. A quantum annealer takes advantage of properties in quantum physics to achieve this, including quantum tunneling, entanglement and superposition. Quantum annealers are complex systems with powerful optimization abilities.

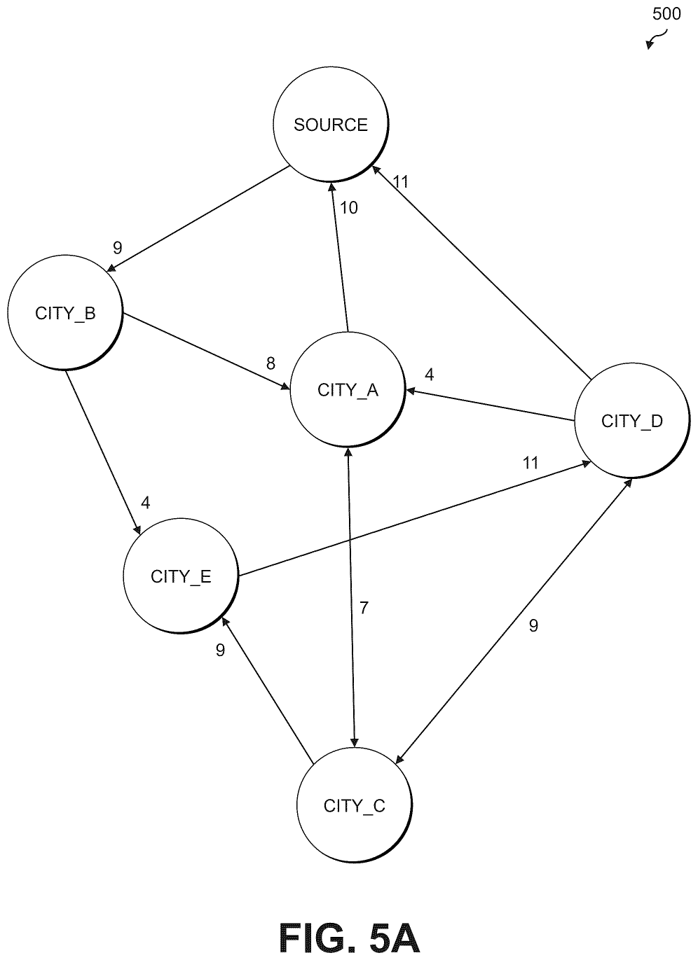

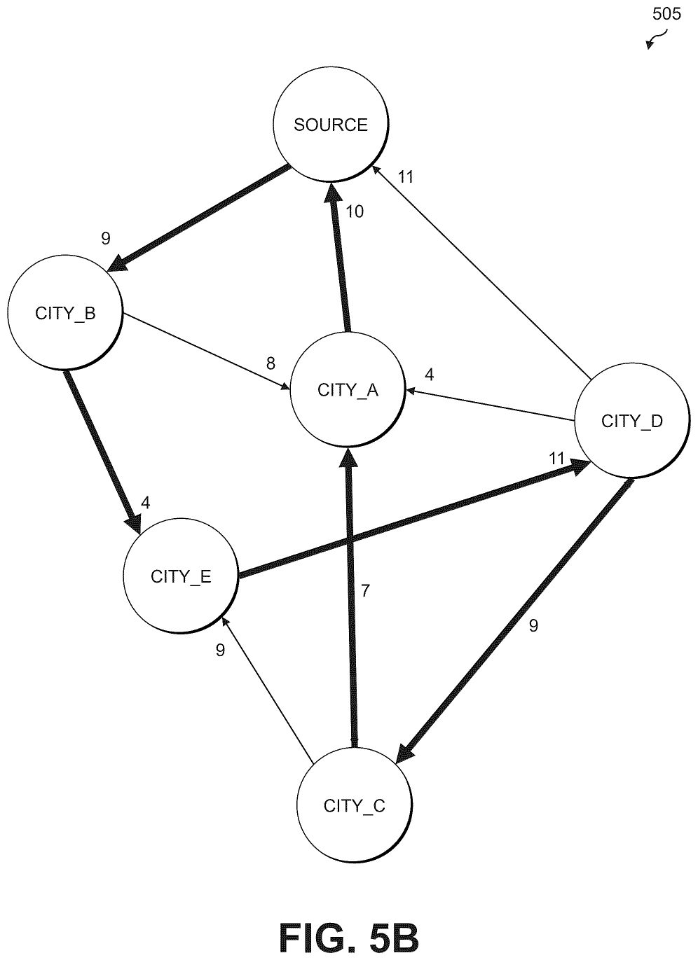

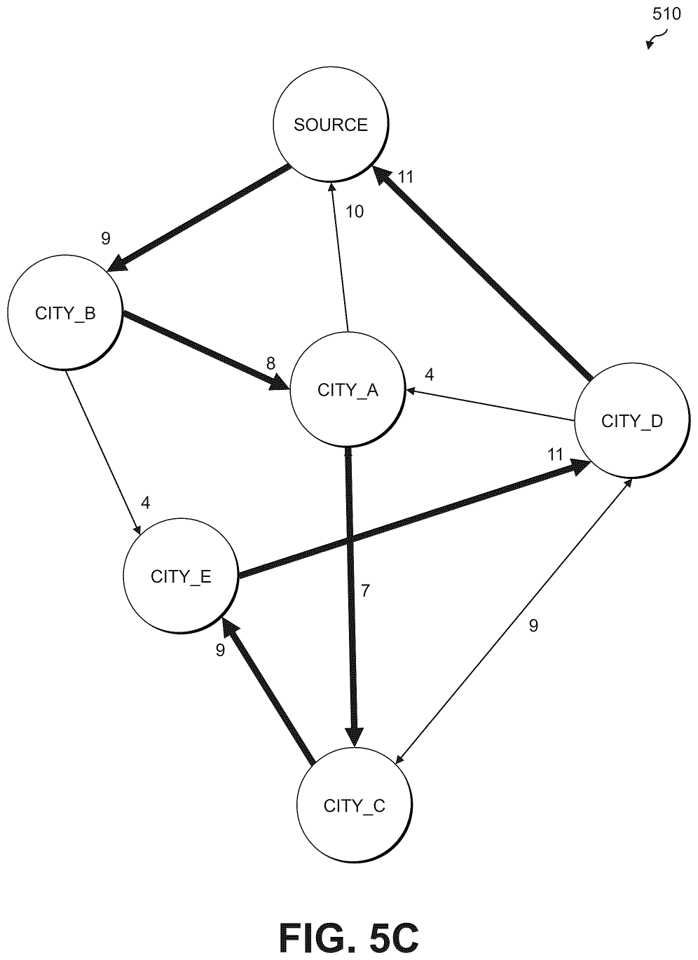

Counterfactual explanations produce actionable insights into model decisions by allowing for the variation of input instances to reach a specific outcome. Counterfactual explanations coupled with a quantum annealer can provide a powerful, explainable and trustworthy solver for optimization problems. An example of such a problem is the traveling salesman problem, which can be solved by an annealer as it selects one of countless possible routes that the traveling salesman can take. FIG. 5A shows a graph 500 representing the possible routes that a traveling salesman can take to visit every city (City_A, City_B, City_C, City_D and City_E) once and get back to the source city (Source) following the shortest path. The nodes of the graph 500 represent the cities, while the edges represent the distances between cities (along with directionality as to whether travel is possible in one or both directions between pairs of cities). In the example of graph 500, the salesman has two possible routes to take, which are shown in FIGS. 5B and 5C. FIG. 5B shows a first route 505 overlayed on the graph 500, which has a total distance of 50. FIG. 5C shows a second route 510 overlayed on the graph 500, which has a total distance of 55. Since the salesman wants to travel the least distance, the first route 505 will be chosen.

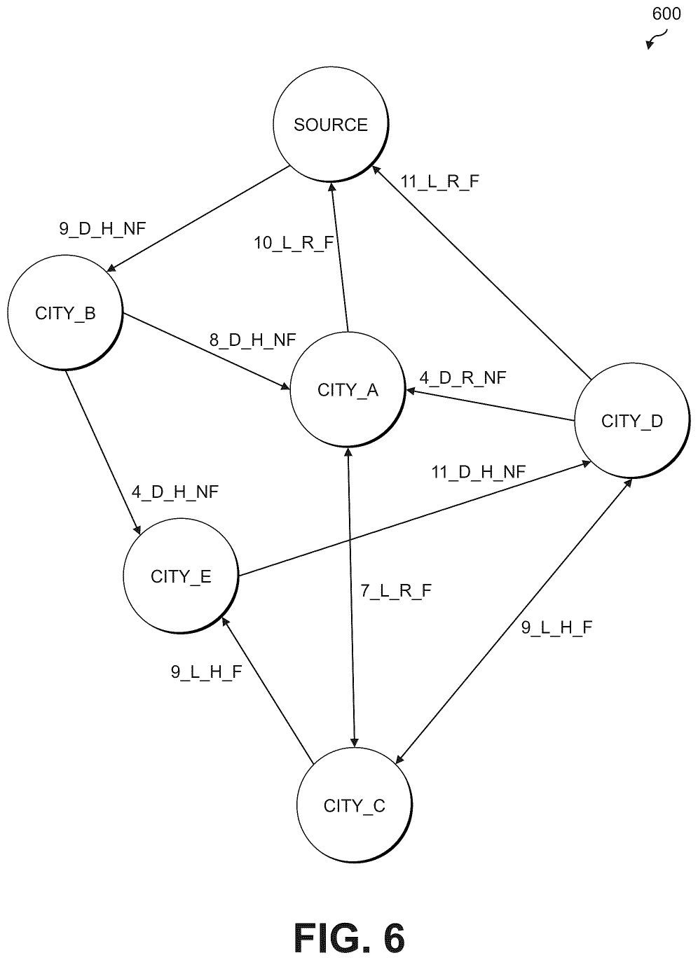

The example of FIGS. 5A-5C is easy to follow and solve even without a quantum annealer. However, as the features to be optimized are increased, this problem quickly becomes more and more difficult to solve. For example, the problem may also take into account various other factors in addition to determining the path of shortest distance, such a determining a “safe” path (e.g., a path which is not dark), a path which is on a highway (e.g., so that the salesman can travel faster), a path which has fuel stations (e.g., for refueling the salesman's vehicle), etc. FIG. 6 shows a new representation 600 of the graph 500, with such features added. In the representation 600, the edges of the graph are in the format: <distance>_<light(L)/dark(D)>_<highway(H)/regular road(R)>_<has fuel station(F)/has no fuel station (NF)>. As can be seen, the problem has gotten more complicated but may still be easy to solve because there are exactly two possible routes as shown previously in FIGS. 5B and 5C and, therefore, it is not overly difficult to decide on one. This problem gets more complex if the number of cities (and, accordingly, the number of possible paths) increase. At some point, it is infeasible to solve the problem and a quantum annealer may be needed. The quantum annealer is guaranteed to find the most optimal solution from the search space available. However, the traveling salesman does not necessarily have to trust the outcome of the quantum annealer and may desire to learn why other routes will not work to take better precautions in other upcoming trips. This circles back to the need for counterfactual explanations to justify the outcomes of a quantum annealer. It should be noted that this applies not only to the traveling salesman problem, but also to other optimization problems including those where the search space can be infinite.

The search space considered by a quantum annealer can be of a completely intractable size, resulting in the need to not only explain the result output by the quantum annealer but also to understand why other solutions were disregarded. Purely methodological explanations to a quantum annealing problem may not be sufficient to increase transparency and comprehensibility of the quantum annealer, as methodological explanations lack the foundation to recommend actionable items for further development and improvement.

The context of a problem may touch on many different aspects of the problem. For optimization problems, which are the type supported by annealing processors such as quantum annealers, constraints may involve many variables and many variables will be present in many constraints (as well as potentially the objective function). In some cases, constraints may be loosened and parameters widened in a process to help shake out better and more explainable results for an end user. The technical solutions described herein utilize counterfactuals for exploring a situation that is explicitly not the present reality, and the hallmark effect on an optimization problem will usually be the restriction of constraints and parameter spaces, rather than loosening or relating the constraints and parameter spaces.

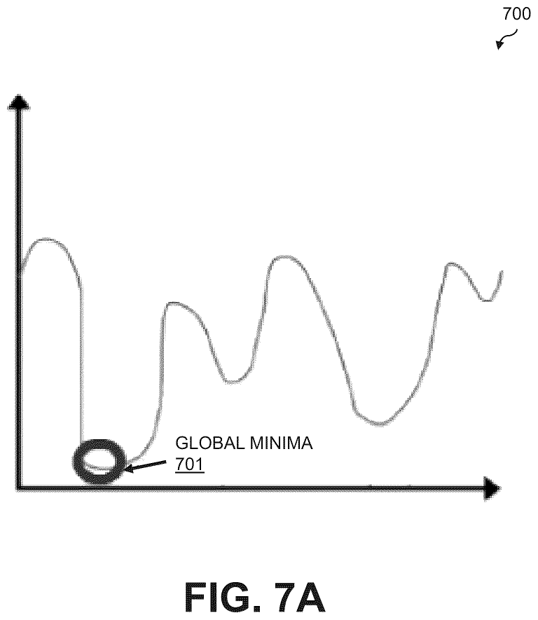

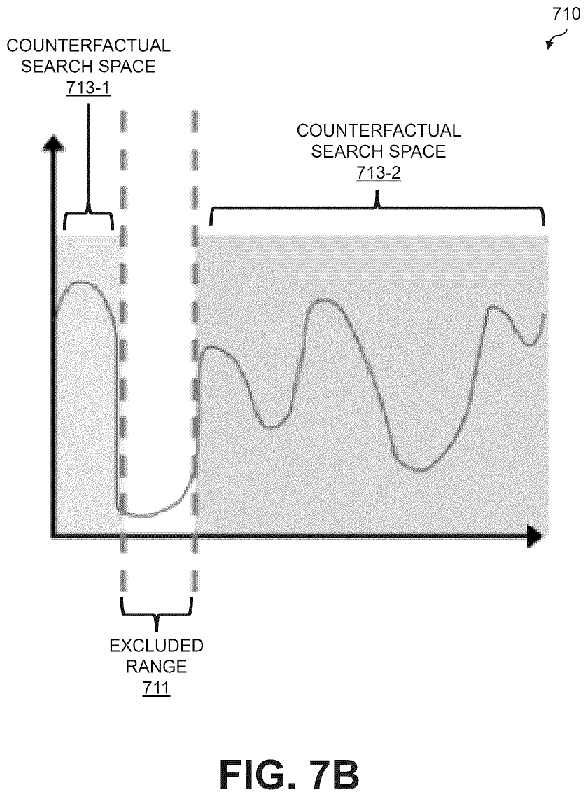

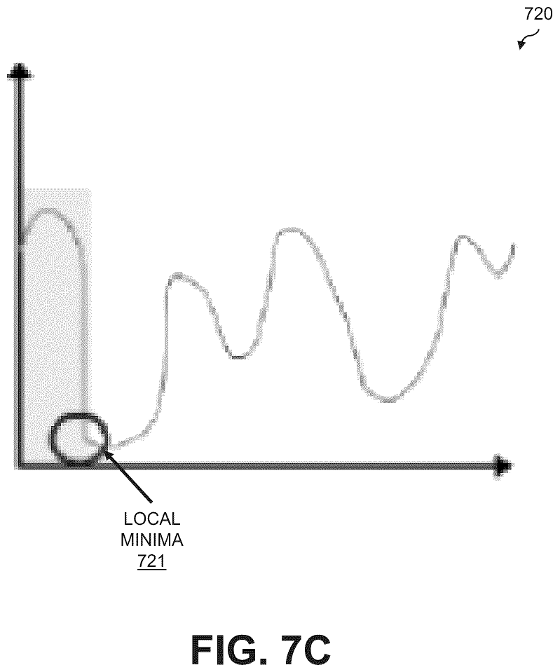

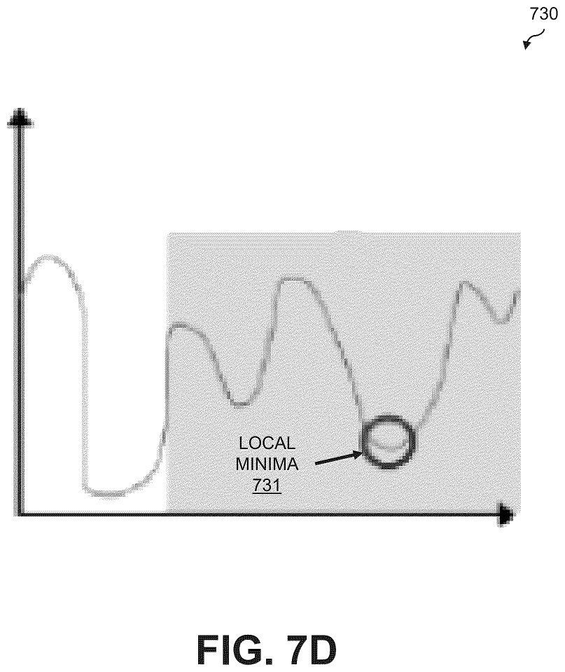

As an example, consider a parameter X which is originally allowed to lie within the range [0,10]. Suppose the energy landscape is minimized near X=3. If the annealer is asked to explore a world in which X must instead be 4 or greater, or 2 or less, the annealer will necessarily find a different solution value. This is represented graphically in FIGS. 7A-7D. FIG. 7A shows a plot 700 illustrating a global minima 701 or solution output for a full search space. FIG. 7B shows a plot 710, illustrating first and second counterfactual search spaces 713-1 and 713-2 (collectively, counterfactual search spaces 713) surrounding an excluded range 711 containing the global minima 701. FIG. 7C shows a plot 720 illustrating the local minima 721 for the first counterfactual search space 713-1. FIG. 7D shows a plot 730 illustrating the local minima 731 for the second counterfactual search space 713-2. An example real-world context will now be described. Consider a restauranter who is considering closing a restaurant on Sunday so as to give waitstaff time to spend with family. The restauranter may have a model for business revenue which is maximized by the restaurant being open 7 days a week. There may, however, be some offset where closing on one day (e.g., Sunday) slightly increases demand on the other six days for individuals who really want to eat at the restaurant. Thus, the restauranter may request an exploration of the model for business revenue for the situation: what will happen to the bottom line if the restaurant is closed on Sundays? Obviously, the restriction of opening hours may affect many things—not only potential revenue, but also possibly reduced expenditure caused by reducing the number of waitstaff hours in a given week. A sufficiently advanced model may even be able to give a weighting for factors such as increased morale, fewer missed shifts, etc. Some assumptions may be made, but many iterations of the annealing can be performed under different weightings to improve the confidence of reported results.

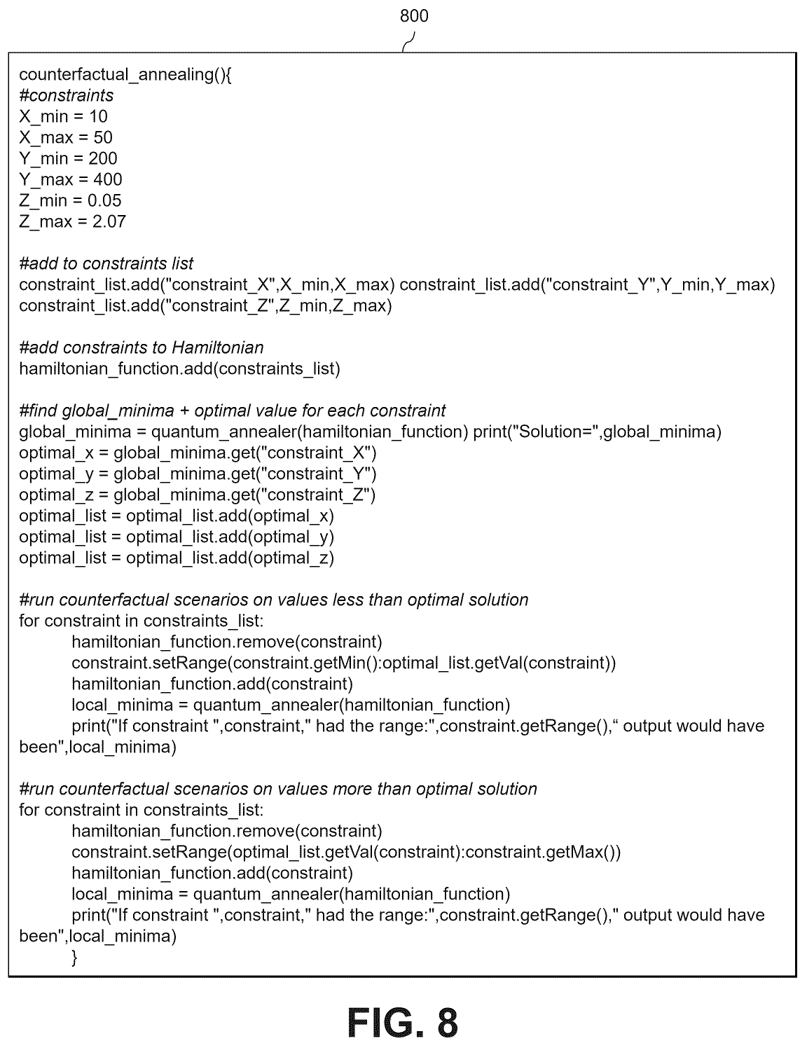

FIG. 8 shows pseudocode 800 for implementing counterfactual searches and generation of counterfactual explanations from an annealer (e.g., a quantum annealer). In the example of FIG. 8, there are three constraints denoted X, Y and Z bounded by minimum and maximum values. The explainer runs the annealer to find the optimal solution of the problem, and then narrows the ranges of the constraints to find suboptimal solutions with the narrowed constraints. The final output of the pseudocode 800 is a description of how the optimal solution chosen by the annealer is the best one, because all others (e.g., the searches with narrowed constraints) are suboptimal.

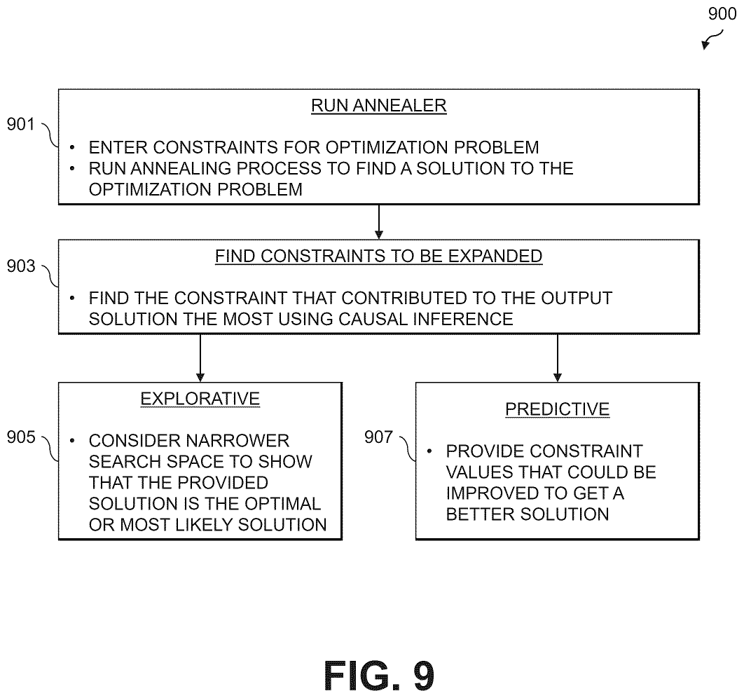

FIG. 9 shows a process flow 900 for an XAI framework, which includes solving an optimization problem using a quantum annealer and outputting the solution along with a counterfactual explanation showing alternative solutions. The process flow 900 begins in step 901 with running an annealer (e.g., a quantum annealer). Step 901 includes entering constraints for an optimization problem, followed by running an annealing process (e.g., a quantum annealing process on a quantum computer, a simulated annealing process on a classical computer, etc.) to find a solution to the optimization problem. In step 903, a constraint to be expanded is selected. This includes performing causal inference to find the constraints that contribute most to the output solution from step 901. In step 905, exploration is performed where a narrower search space for the constraints found in step 903 is considered to show that the solution provided in step 901 is best. In step 907, prediction is performed where constraint values that could be improved to get a better solution (e.g., than that output in step 901) are provided. The output of steps 905 and 907 may be provided to the user.

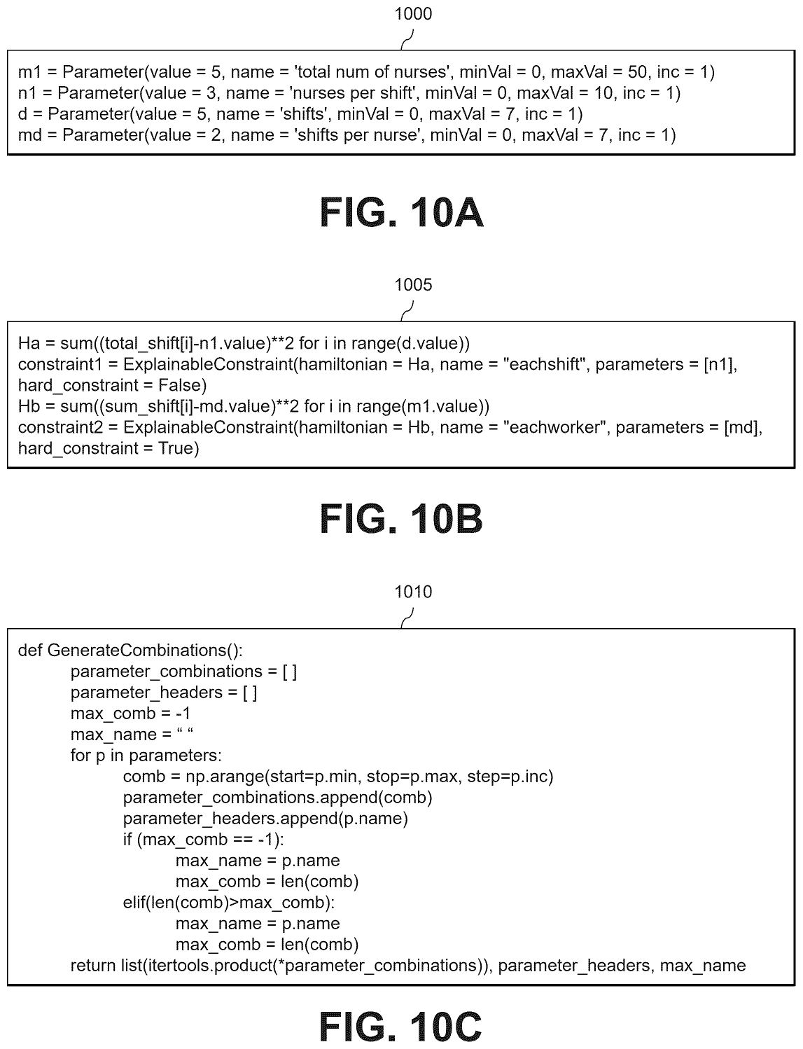

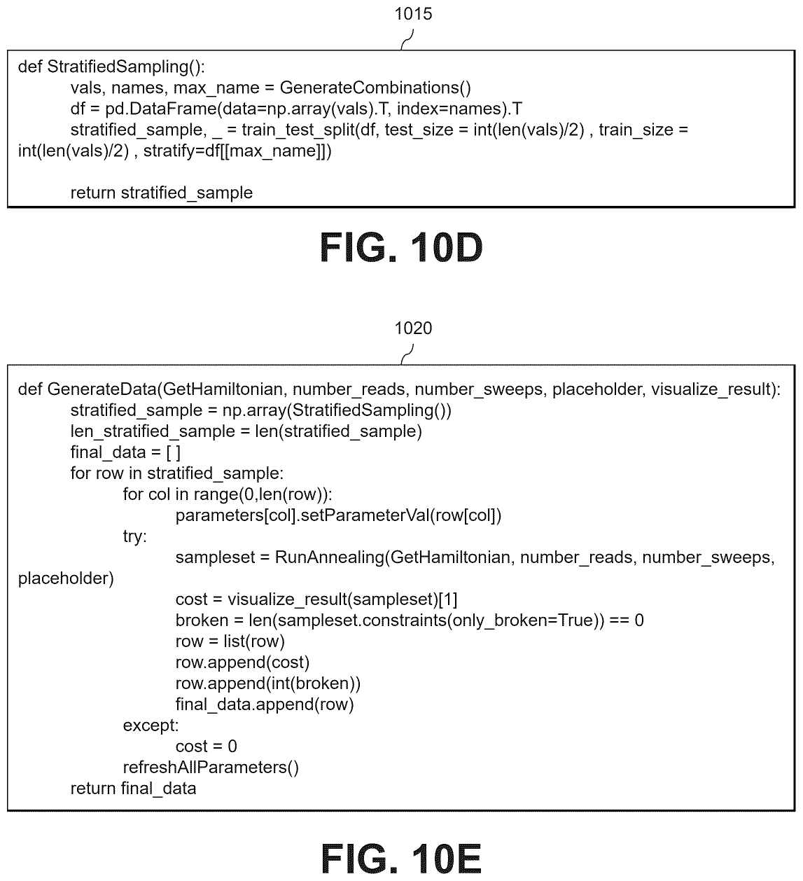

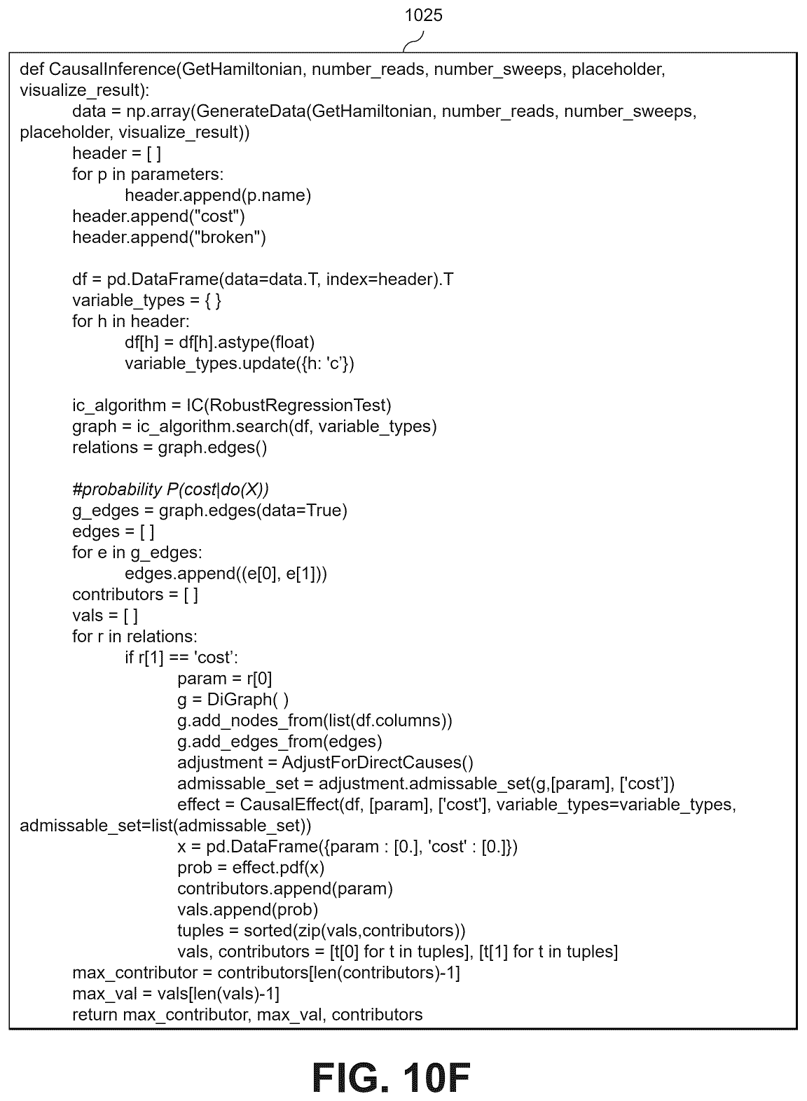

The process flow 900 for the XAI framework will now be described in further detail with respect to a “nurse scheduling” problem. The nurse scheduling problem involves m1 nurses being assigned to d number of shifts to produce a schedule. The schedule is bound by two constraints “eachshift” and “eachworker.” The first constraint, eachshift, requires a number n1 of nurses to be working per shift. The second constraint, eachworker, requires each nurse to work a number of md shifts per schedule. A feasible solution is one that will assign n1 nurses per shift while keeping every nurse occupied md shifts per week. This is a hard optimization problem which can be solved by a quantum annealer. An explainer is first provided by the user with constraints and related parameters of this problem in step 901. This may be done by creating a “Parameter” object for each parameter and an “ExplainableConstraint” object for each constraint. When creating a parameter, the value of the parameter should be input along with a descriptive name, minimum and maximum values that the parameter can have, and how much that parameter can be incremented or decremented. FIG. 10A shows pseudocode 1000 for parameter objects. When creating an explainable constraint, a Hamiltonian for the constraint should be provided along with a name of the constraint, the parameters it covers, and whether it is a hard or soft constraint. FIG. 10B shows pseudocode 1005 for generating constraint objects. After the problem is input into the annealer, the annealer process runs to produce a feasible solution.

In step 903, the largest contributing constraint to the final output is identified. The final counterfactual explanation is expected to suggest an alternative set of parameters to the ones entered initially by the user to give rise to a more optimal solution (e.g., lower cost). This can be done by first identifying the constraint or set of parameters that had the largest effect on the final output using a process referred to as causal inference. Causal inference involves determining the independent and true effect a specific phenomenon possesses as part of a larger system. It is different from inference of association as it is focused on identifying the effect a variable has on another by observing changes in the causes of effect.

In some embodiments, an Inductive Causation (IC) algorithm is used, which is a score-based approach where the quality of the produced causal graph is based on a scoring metric called the Bayesian Information Criterion (BIC). The algorithm searches for the most likely causal relationships given the data provided. Since only a single set of parameter values and corresponding output is available, a collection of data points is generated to be entered into the IC algorithm. This means that a variety of input parameters along with the annealer output must be recorded. This is done using three methods, referred to as GenerateCombinations, StratifiedSampling and GenerateData. GenerateCombinations generates a combination of all possible parameter values given the input range of permissible values as shown in the pseudocode 1010 of FIG. 10C. Next, only a sample of the generated data is utilized, since the full set of data is redundant and may require a tremendous amount of annealer runs to produce each corresponding result. As a result, StratifiedSampling extracts a sampling of the generated data using stratified sampling. This sampling method offers a greater sampling precision by dividing a population into strata based on specific characteristics. FIG. 10D shows pseudocode 1015 for implementing the StratifiedSampling method. Finally, the GenerateData method runs the annealer for every parameter value combination chosen by the stratified sampler. FIG. 10E shows pseudocode 1020 for implementing the GenerateData method. The cost of every run, along with any broken constraints, are saved (e.g., in a comma-separated value (CSV) file). After the data is generated, the IC algorithm is applied on it, generating a graph where nodes represent causes and edges point from cause to effect. Afterwards, the posterior probability of every cause-effect relationship is calculated to rank the parameters from most affecting to least affecting. Once the parameter with the maximum contribution is discovered, the explorative and predictive explanations can be generated in steps 905 and 907, respectively. FIG. 10F shows pseudocode 1025 for implementing the IC algorithm.

In step 905, the explorative explanation is produced. An explorative explanation justifies the annealer's selection of a particular output solution by showing that it is the best available given the provided constraints and parameter values. This results in an explanation like:
“The solution produced is the best available since if the parameter range was any smaller, the output would have been . . .
If the parameter range were any bigger, the output would have been . . . ”
   The explorative explanation may be generated by eliminating the current parameter configuration from the solution space (e.g., the excluded range 711 shown in the plot 710 of FIG. 7B described above), and evaluating the range below (e.g., the counterfactual search space 713-1 shown in the plot 710 of FIG. 7B and the plot 720 of FIG. 7C) and above (e.g., the counterfactual search space 713-2 shown in the plot 710 of FIG. 7B and the plot 730 of FIG. 7D) that parameter configuration in search for a better solution. It is assumed that the annealer has already discovered the global minima and therefore the values discovered are considered local minima (e.g., the local minima 721 and 731 shown in the plots 720 and 730 of FIGS. 7C and 7D, respectively) which will not be better than the original solution (e.g., the global minima 701 shown in the plot 700 of FIG. 7A) provided by the annealer. Hence, the user gets outputs explaining that the exploration of other solutions is unnecessary since the one produced by the annealer is the most optimized and most feasible.

In step 907, the predictive explanation is produced. In some embodiments, it is desired to include a predictive explanation along with its explorative counterpart. This serves as a component of the final counterfactual explanation, generating a hypothetical reality that contradicts the observed facts which actions and insights could be drawn from. The predictive explanation describes how a change in the given parameters can result in a better solution, resulting in an explanation like:
“Changing variable V1 to value X1, variable V2 to value X2, and variable V2 to value X2 will result in a better output of . . . ”

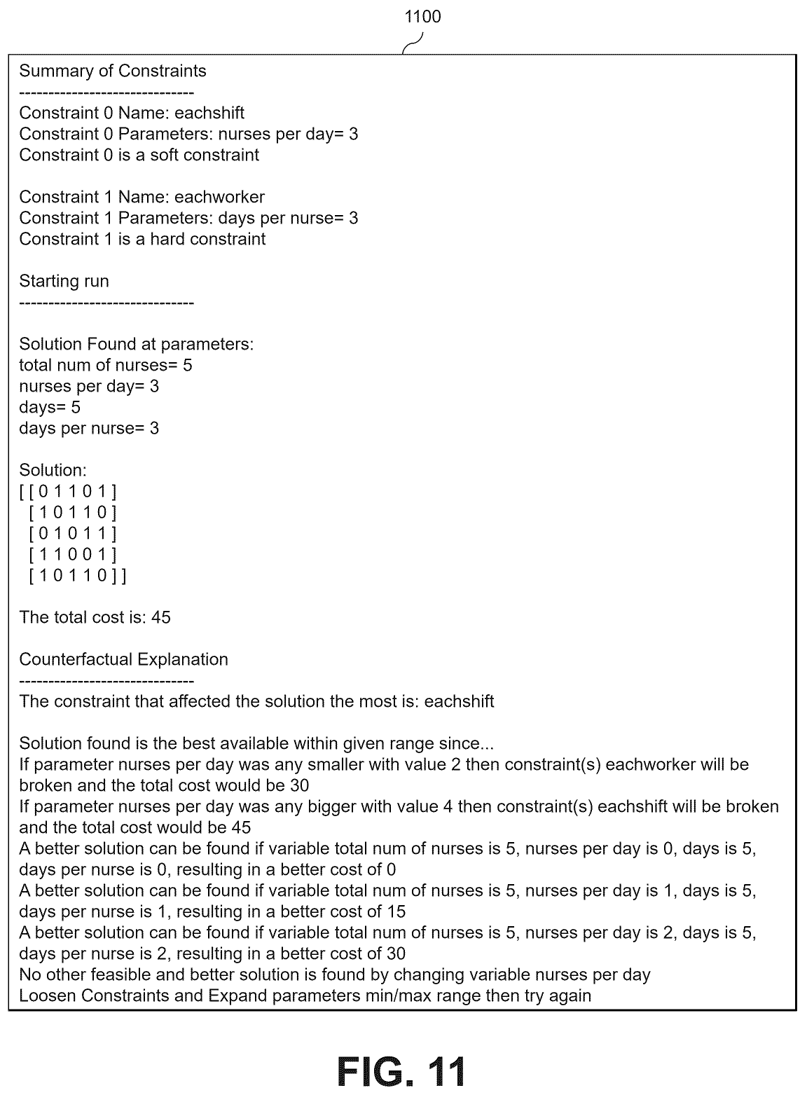

There is, possibly, a plethora of more optimized suggestions that could be offered as output of the XAI framework. The XAI framework, however, will focus on prioritizing those that involve the least amount of change in the input parameter values. This is so the suggestion provided is as feasible as possible and one that will require the least effort to realize. Overall, the user can interact with the XAI framework to request more suggestions until the solution space is exhausted, as evident in the example output text shown in FIG. 11. FIG. 11 shows an example output 1100 for the nurse scheduling problem with the following parameter configuration: m1=5, n1=3, D=5, md=3. It should be noted that the example output 1100 shown in FIG. 11 is one in which the user exhausted the solution space by requesting the XAI framework to see a different solution three separate times.

The technical solutions described herein provide an approach for automated reconfiguration and restriction of parameters spaces and constraints for AI systems based on counterfactual information. The technical solutions further provide for iterated performance of annealing in order to improve confidence and accuracy of predictions of AI systems based on uncertain assumptions coming from counterfactual instructions.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

Illustrative embodiments of processing platforms utilized to implement functionality for generating counterfactual explanations for solutions to optimization problems obtained utilizing AI systems will now be described in greater detail with reference to FIGS. 12 and 13. Although described in the context of system 100, these platforms may also be used to implement at least portions of other information processing systems in other embodiments.

FIG. 12 shows an example processing platform comprising cloud infrastructure 1200. The cloud infrastructure 1200 comprises a combination of physical and virtual processing resources that may be utilized to implement at least a portion of the information processing system 100 in FIG. 1. The cloud infrastructure 1200 comprises multiple virtual machines (VMs) and/or container sets 1202-1, 1202-2, . . . 1202-L implemented using virtualization infrastructure 1204. The virtualization infrastructure 1204 runs on physical infrastructure 1205, and illustratively comprises one or more hypervisors and/or operating system level virtualization infrastructure. The operating system level virtualization infrastructure illustratively comprises kernel control groups of a Linux operating system or other type of operating system.

The cloud infrastructure 1200 further comprises sets of applications 1210-1, 1210-2, . . . 1210-L running on respective ones of the VMs/container sets 1202-1, 1202-2, . . . 1202-L under the control of the virtualization infrastructure 1204. The VMs/container sets 1202 may comprise respective VMs, respective sets of one or more containers, or respective sets of one or more containers running in VMs.

In some implementations of the FIG. 12 embodiment, the VMs/container sets 1202 comprise respective VMs implemented using virtualization infrastructure 1204 that comprises at least one hypervisor. A hypervisor platform may be used to implement a hypervisor within the virtualization infrastructure 1204, where the hypervisor platform has an associated virtual infrastructure management system. The underlying physical machines may comprise one or more distributed processing platforms that include one or more storage systems.

In other implementations of the FIG. 12 embodiment, the VMs/container sets 1202 comprise respective containers implemented using virtualization infrastructure 1204 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1200 shown in FIG. 12 may represent at least a portion of one processing platform. Another example of such a processing platform is processing platform 1300 shown in FIG. 13.

The processing platform 1300 in this embodiment comprises a portion of system 100 and includes a plurality of processing devices, denoted 1302-1, 1302-2, 1302-3, . . . 1302-K, which communicate with one another over a network 1304.

The network 1304 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1302-1 in the processing platform 1300 comprises a classical processor 1310 and a quantum processor 1312, which are coupled to one another and a memory 1314.

The classical processor 1310 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The quantum processor 1312 may comprise a quantum computing chip that includes a number of quantum bits or qubits. The quantum processor 1312 may be an annealing-based quantum processor, an analog quantum processor, a circuit-based quantum processor, as well as portions of combinations of such elements.

The memory 1314 may comprise random access memory (RAM), read-only memory (ROM), flash memory or other types of memory, in any combination. The memory 1314 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1302-1 is network interface circuitry 1316, which is used to interface the processing device with the network 1304 and other system components, and may comprise conventional transceivers.

The other processing devices 1302 of the processing platform 1300 are assumed to be configured in a manner similar to that shown for processing device 1302-1 in the figure. It should be noted, however, that in the processing platform 1300 some of the processing devices 1302 may include instances of both the classical processor 1310 and the quantum processor 1312, while other ones of the processing devices 1302 may include only an instance of the classical processor 1310 or only an instance of the quantum processor 1312. One or more of the processing devices 1302 may include multiple instances of the classical processor 1310 and/or multiple instances of the quantum processor 1312.

Again, the particular processing platform 1300 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality for generating counterfactual explanations for solutions to optimization problems obtained utilizing AI systems as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems, annealers, etc. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. An apparatus comprising:
at least one processing device comprising a processor coupled to a memory;
the at least one processing device being configured:
to generate a configuration of an artificial intelligence system for solving an optimization problem, the generated configuration comprising one or more parameters, each of the one or more parameters having an associated parameter value range;
to execute one or more annealing processes in the artificial intelligence system with the generated configuration to determine a given solution to the optimization problem;
to generate one or more counterfactual configurations of the artificial intelligence system;
to execute the one or more annealing processes in the artificial intelligence system with the generated one or more counterfactual configurations to determine counterfactual information for the given solution to the optimization problem;
to generate feedback for the artificial intelligence system based at least in part on the determined counterfactual information; and
to control one or more characteristics of the artificial intelligence system based at least in part on the generated feedback.

2. The apparatus of claim 1 wherein the feedback comprises an explanation of optimality of the given solution to the optimization problem relative to the determined counterfactual information.

3. The apparatus of claim 1 wherein the determined counterfactual information comprises one or more counterfactual explanations, each of the one or more counterfactual explanations comprising an alternate solution to the optimization problem.

4. The apparatus of claim 1 wherein the artificial intelligence system comprises a quantum annealer implementing the one or more annealing processes.

5. The apparatus of claim 1 wherein a given one of the one or more counterfactual configurations comprises at least one modified parameter value range for at least one of the one or more parameters.

6. The apparatus of claim 5 wherein the at least one modified parameter value range for said at least one of the one or more parameters comprises a narrower parameter value range for said at least one of the one or more parameters.

7. The apparatus of claim 1 wherein generating a given one of the one or more the counterfactual configurations comprises:
selecting a given one of the one or more parameters associated with the given solution to the optimization problem; and
generating a given modified parameter value range for the given parameter for the given counterfactual configuration, the given modified parameter value range excluding a value of the given parameter associated with the given solution to the optimization problem.

8. The apparatus of claim 7 wherein the given parameter is selected based at least in part on determining impacts of two or more different ones of the one or more parameters on the given solution to the optimization problem, wherein the impacts of the two or more different ones of the one or more parameters on the given solution to the optimization problem are determined based at least in part on identifying contributions of two or more constraints of the optimization problem to the given solution to the optimization problem, the two or more constraints being associated with different subsets of the one or more parameters of the optimization problem.

9. The apparatus of claim 8 wherein the impacts of the two or more different ones of the one or more parameters on the given solution to the optimization problem are determined utilizing a causal inference algorithm, wherein the causal inference algorithm comprises an Inductive Causation (IC) algorithm utilizing a Bayesian Information Criterion (BIC) scoring metric.

10. The apparatus of claim 1 wherein generating a given one of the one or more counterfactual configurations comprises:
selecting a given one of the one or more parameters associated with the given solution to the optimization problem; and
generating a given modified parameter value range for the given parameter for the given counterfactual configuration, the given modified parameter value range comprising a value range that is one of (i) greater than a value of the given parameter associated with the given solution to the optimization problem and (ii) less than a value of the given parameter associated with the given solution to the optimization problem.

11. The apparatus of claim 1 wherein generating the one or more counterfactual configurations comprises:
selecting a given one of the one or more parameters associated with the given solution to the optimization problem;
generating a first modified parameter value range for the given parameter for a first one of the one or more counterfactual configurations, the first modified parameter value range comprising a first value range less than a value of the given parameter associated with the given solution to the optimization problem; and
generating a second modified parameter value range for the given parameter for a second one of the one or more counterfactual configurations, the second modified parameter value range comprising a second value range greater than the value of the given parameter associated with the given solution to the optimization problem.

12. The apparatus of claim 1 wherein generating the feedback for the artificial intelligence system comprises identifying one or more modifications to the optimization problem to increase an optimality of the given solution to the optimization problem, the one or more modifications to the optimization problem comprising one or more changes to at least one of (i) one or more parameter value ranges for the one or more parameters of the optimization problem and (ii) one or more constraints of the optimization problem.

13. The apparatus of claim 1 wherein:
the given solution to the optimization problem specifies one or more controls for a physical system which provide a first level of performance of the physical system;
the determined counterfactual information specifies alternate sets of the one or more controls for the physical system providing one or more second levels of performance of the physical system, the one or more second levels of performance of the physical system being less than the first level of performance of the physical system; and
the at least one processing device is further configured to adjust the one or more controls of the physical system based at least in part on the given solution to the optimization problem and the determined counterfactual information.

14. The apparatus of claim 13 wherein the physical system comprises one or more information technology assets of an information technology infrastructure.

15. A computer program product comprising a non-transitory processor-readable storage medium having stored therein program code of one or more software programs, wherein the program code when executed by at least one processing device causes the at least one processing device:
to generate a configuration of an artificial intelligence system for solving an optimization problem, the generated configuration comprising one or more parameters, each of the one or more parameters having an associated parameter value range;
to execute one or more annealing processes in the artificial intelligence system with the generated configuration to determine a given solution to the optimization problem;
to generate one or more counterfactual configurations of the artificial intelligence system;
to execute the one or more annealing processes in the artificial intelligence system with the generated one or more counterfactual configurations to determine counterfactual information for the given solution to the optimization problem;
to generate feedback for the artificial intelligence system based at least in part on the determined counterfactual information; and
to control one or more characteristics of the artificial intelligence system based at least in part on the generated feedback.

16. The computer program product of claim 15 wherein the artificial intelligence system comprises a quantum annealer implementing the one or more annealing processes.

17. The computer program product of claim 15 wherein generating a given one of the one or more counterfactual configurations comprises:
selecting a given one of the one or more parameters associated with the given solution to the optimization problem; and
generating a given modified parameter value range for the given parameter for the given counterfactual configuration, the given modified parameter value range excluding a value of the given parameter associated with the given solution to the optimization problem.

18. A method comprising:
generating a configuration of an artificial intelligence system for solving an optimization problem, the generated configuration comprising one or more parameters, each of the one or more parameters having an associated parameter value range;
executing one or more annealing processes in the artificial intelligence system with the generated configuration to determine a given solution to the optimization problem;
generating one or more counterfactual configurations of the artificial intelligence system;
executing the one or more annealing processes in the artificial intelligence system with the generated one or more counterfactual configurations to determine counterfactual information for the given solution to the optimization problem;
generating feedback for the artificial intelligence system based at least in part on the determined counterfactual information; and
controlling one or more characteristics of the artificial intelligence system based at least in part on the generated feedback;
wherein the method is performed by at least one processing device comprising a processor coupled to a memory.

19. The method of claim 18 wherein the artificial intelligence system comprises a quantum annealer implementing the one or more annealing processes.

20. The method of claim 18 wherein generating a given one of the one or more counterfactual configurations comprises:
selecting a given one of the one or more parameters associated with the given solution to the optimization problem; and
generating a given modified parameter value range for the given parameter for the given counterfactual configuration, the given modified parameter value range excluding a value of the given parameter associated with the given solution to the optimization problem.
